(19) United States
(12) Patent Application Publication
(10) Pub. No.: US 2009/0311036 A1
(43) Pub. Date: Dec. 17, 2009

(54) DISPENSING DEVICE FOR CONSUMER PRODUCTS

(75) Inventors: Leo Clifford Pires, Basking Ridge, NJ (US); Roger Hwang, Maple (CA); Abhisek Basak, New Delhi (IN); Santosh Mohapatra, New Delhi (IN); Rahul Bose, New Delhi (IN); Koushik Kohli, Ghaziabad (IN)

Correspondence Address: PATTERSON & SHERIDAN L.L.P. NJ Office, 3040 Post Oak Boulevard, Suite 1500, Houston, TX, 77056-6582, US

(73) Assignee: Zen Design Solutions Limited, Wanchai (HK)

(21) Appl. No.: 12/266,205

(22) Filed: Nov. 6, 2008

Related U.S. Application Data
(63) Continuation-in-part of application No. 12/137,617, filed on Jun. 12, 2008.

(51) Int. Cl. B43M 11/06; B43K 1/00

(52) U.S. Cl. 401/263; 401/292; 401/265

(57) ABSTRACT

The present invention generally is a dispensing device for consumer products which is user-friendly and provides an easy application by the user. The device allows a user to simultaneously actuate while applying. The disclosed device provides for controllable dispensing of the product and is user friendly as it is one-hand operated. There is provided a device that provides an even application on the surface as there is present a shearing assembly inside it. The device of the present invention can be used to dispense a wide variety of consumer products such as cosmetic, cosmeceutical and care products such as nail enamel, foundation, hair treatment or skin care products.

### CROSS-REFERENCE TO RELATED APPLICATION

This application is a continuation-in-part of U.S. patent application Ser. No. 12/137,617, filed Jun. 12, 2008, which is incorporated by reference in its entirety.

### BACKGROUND

1. Field of the Invention

Embodiments of the present invention generally relate to a dispensing device for consumer products. More particularly the invention relates to a device that allows a user to simultaneously actuate while applying. The device of the present invention provides for controllable dispensing of the product and is user friendly as it is one-hand operated. The device is locked when the cap is on thereby preventing accidental actuation/leakage during storage. Also, the device shows color when on shelf thereby making the product easily-identifiable.

The device of the present invention can be used to dispense a wide variety of consumer products such as cosmetic, cosmeceutical and care products such as nail enamel, foundation, hair treatment or skin care and regimen products.

2. Description of the Related Art

Various devices exist for dispensing of fluid substances such as cosmetic or care products. Generally the products are contained in a container comprising a receptacle having a cap, and there may also be present a mechanism to dispense the product. The mechanism for dispensing the product may be a pump or a piston propelled mechanism. In recent past, a lot of pen-like devices have been marketed as they are considered to be easy-to-use. Such pen-like devices comprise an outer shell/housing, a cap, a movable mechanism inside the housing and an actuator. The actuators are generally present at the bottom of the device and may comprise a click mechanism or a rotor mechanism.

U.S. Pat. No. 6,688,796 to Liu discloses a device having a press/push actuator. U.S. Patent Application No. 2005/0053415 uses a pump mechanism inside a pen body while U.S. Pat. No. 7,086,796 discloses a cosmetic pen using a push mechanism for actuating the dispensing mechanism.

However, the disadvantage associated with these existing devices is that they engage both the hands of the user for actuation, one to hold the housing and the other to impart rotation of the mechanism. These devices are difficult to operate as the user has to alter between actuation and application due to the presence of the actuator at the bottom of the device. Further, such devices do not provide the user with an option to simultaneously actuate while application so that the flow is not broken while application. Moreover, these devices are posed with a problem of accidental actuation when the device is not in usage or under storage.

Further, these existing devices generally contain a shut-off valve which opens when the product is to be used. However, these valves act just as a usual shut-off valve, whereas sometimes, the valve may get blocked and may not be able to let the fluid flow when the fluid is very thick.

Therefore, there is a need in the art for a dispensing device that takes care of all the above problems, is user-friendly and provides easy actuation while application. There is also a need for a device that gives the user an even application. It would also be desirable if the device provides for a replaceable cartridge system in it.

### SUMMARY

The present invention generally is a dispensing device for consumer products. The device allows a user to simultaneously actuate while applying. The device of the present invention provides for controllable dispensing of the product and is user friendly as it is one-hand operated. Further, the device is locked when the cap is on thereby preventing accidental actuation/leakage during storage. Also, the device shows color and kind of formulation stored in the reservoir thereby being easily-identifiable.

The device of the present invention can be used to dispense a wide variety of consumer products such as cosmetic, cosmeceutical and care products such as nail enamel, foundation, hair treatment or skin care products.

The present invention provides for an applicator device that allows for simultaneous actuation and application of product. The present invention also provides for a shearing assembly inside the device that provides shearing as well as sealing of the product flow. There is provided a device that provides an even application on the surface. The usage of this device would ensure that there are no clots of product blocking the path of fluid flow.

According to an embodiment of the invention there is provided a device which is user-friendly and provides an easy application by the user. The device provides for one-hand operation and convenient side-actuation thereby allowing the user to apply products on-the-go. The device of the present invention helps in actuation while application.

According to an embodiment of the invention there is provided a device that cannot be actuated during storage. Further, there is provided a device that shows color and kind of formulation stored in the reservoir and is easily identifiable by the user.

According to another embodiment of the invention, the device comprises of an outer body and a closure means for the same. The outer body is hollow and accommodates a reservoir, an actuating means and a shearing assembly. The reservoir contains the product. The reservoir is arranged to be in fluid communication with the shearing assembly while the actuating means is operatively connected to the reservoir. The shearing assembly comprises of a housing that houses a shearing component and an applicator element. The housing of the shearing component has at least one aperture at its distal end to allow fluid flow. The shearing component is fixedly connected to the outer body while the housing of the shearing component is connected with the reservoir. Further, the shearing component has a plurality of flow tracks in it and a solid region. The shearing component has a projection at its distal end arising from the solid region that fits onto the aperture of the housing thereby providing sealing action for flow of product. Furthermore, the movement of the reservoir with respect to the outer body is biased by a biasing member thereby allowing the reservoir to move in a translation motion upon application of a force.

According to another embodiment of the invention, the arrangement of the reservoir with respect to the outer body is such that the distal end of the reservoir is visible from the outer body thereby showing the kind and color of the formulation stored in the reservoir.

In accordance with yet another embodiment of the invention, the actuating means is arranged such that its movement causes the reservoir to displace axially and cause the flow of product to the applicator. The actuating means may be any suitable means such as a slider, a push-button or a rotor.

According to another embodiment of invention, the actuating means may be connected to the reservoir by way of a cam profile. The actuating means may have an inclined cam profile that corresponds to a similar profile on the reservoir. When the actuating means is actuated by the user, a force is applied on the reservoir and the reservoir is displaced axially which in turn takes the housing of the shearing assembly along with it thereby opening the passage for the product to flow through the shearing component onto the applicator.

In accordance with yet another embodiment of the invention, the closure means is so arranged to lock the actuating means when closure means is put on the device. Locking may be achieved by any suitable means. For example, the closure means may fit in between the gap of actuating means and reservoir or there may be provided indentations on the actuating means that engage with the indentations on the cap when the cap is put on the device. Therefore, the actuating means is locked when the device is not in use.

According to yet another embodiment of the invention, the outer surface of the reservoir has indentations which prevent the reservoir from being accidentally pushed during storage and thereby ensuring that the device is spill-proof.

According to another embodiment of the invention, when the device is closed, the closure means such as a cap sits on the proximal end of the outer body such that the actuating means is locked and its movement is blocked. Further, in closed position, the housing and the shearing component of the shearing assembly are caused to be placed abutting each other and there is no flow of product taking place.

According to yet another embodiment of the invention, during operation first the closure means is removed from the device to bring the device in open position. In open position, when the actuating means is actuated, the housing and the shearing component are placed apart as the reservoir has displaced axially taking the housing of the shearing assembly along with it. Further, the aperture of the housing is now open to allow the flow of fluid through the flow tracks of the shearing component onto the applicator.

According to yet another embodiment of the invention, the materials for making various parts of the dispensing device are selected as per the compatibility of the materials with the kind of formulation stored in the reservoir. The outer body may be made of acrylonitrile butadiene styrene or any suitable polymeric material, while the closure means may be made from polypropylene or any suitable polymeric material. The housing of the shearing assembly and the shearing component may be made from any suitable material or a mixture of suitable polymeric materials, for example, the housing may be made from polypropylene and the shearing component may be made from hytrel or low density polyethylene or from a proportionate mixture of low density polyethylene and high density polyethylene. The actuating means may be made from a suitable polymeric material such as acrylonitrile butadiene styrene or polypropylene. The reservoir may be made of polyamide or a suitable polymeric material depending upon the product to be filled in the reservoir. The biasing member is a resilient flexible member and could be a coil spring or such biasing element. The plug of the biasing member may be made from polypropylene or any suitable material.

According to yet another embodiment of the invention, the device may be provided with different kinds of applicator elements which could be used interchangeably thereby providing a wide usage of the device. Further, the reservoir may be made in the form of a replaceable cartridge which could be changed after each use or changed once the product is finished.

According to yet another embodiment of the invention, the shapes and profile cross section of the device may be of any suitable shape such as cylindrical, square, rectangular, circular, polygonal.

According to yet another embodiment of the invention, the device of the present invention may also serve as a kit with varied options of products in the form of different cartridges in a single package wherein the cartridges may be replaced as per users requirement.

These and further aspects which will be apparent to the expert of the art are attained by a dispensing device for consumer products in accordance with the main claim.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of a dispensing device according to one embodiment of the present invention;

FIG. 2 is an exploded view of the device of FIG. 1;

FIG. 3 illustrates a cross-sectional view of the device of FIG. 1 in closed position in accordance with one embodiment of the invention;

FIG. 4 shows a front view of the actuating means of the dispensing device according to one embodiment of the present invention;

FIG. 4a illustrates a side view of the actuating means of the dispensing device shown in FIG. 4;

FIG. 4b shows a cross-section of side view of the actuating means of the dispensing device shown in FIG. 4;

FIG. 4c shows an isometric view of the actuating means of the dispensing device shown in FIG. 4;

FIG. 4d shows an enlarged cross-sectional view of Detail C of the view of actuating means of the dispensing device shown in FIG. 4b;

FIG. 4e shows an enlarged view of Detail B of the view of actuating means of the dispensing device shown in FIG. 4b;

FIG. 5 illustrates a cross-sectional view of the device of FIG. 3 showing the details of the dispensing mechanism according to one embodiment of the present invention;

FIG. 6 illustrates a cross-sectional view of the device of FIG. 5 in open position according to one embodiment of the present invention;

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

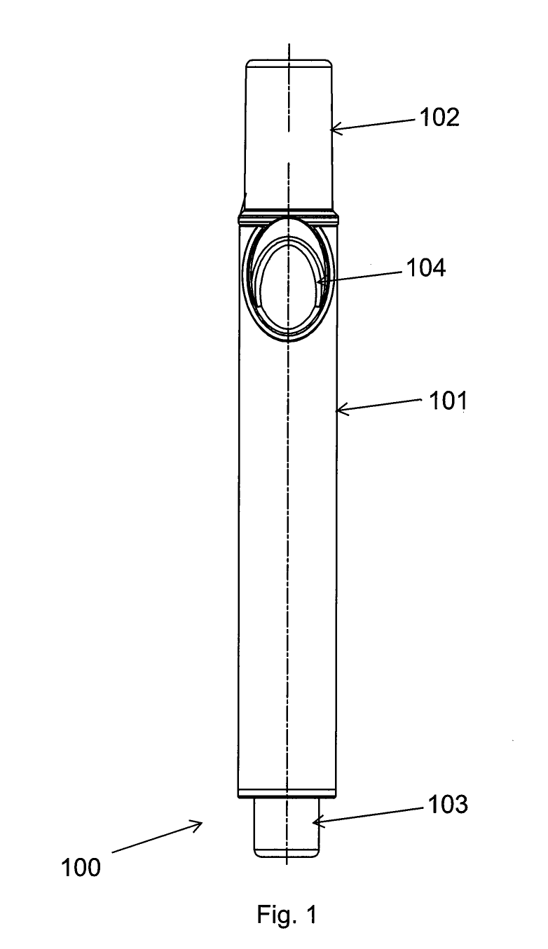

FIG. 1 is one embodiment of the present invention showing a dispensing device 100 for consumer products that provides simultaneous actuation and application of product onto a surface.

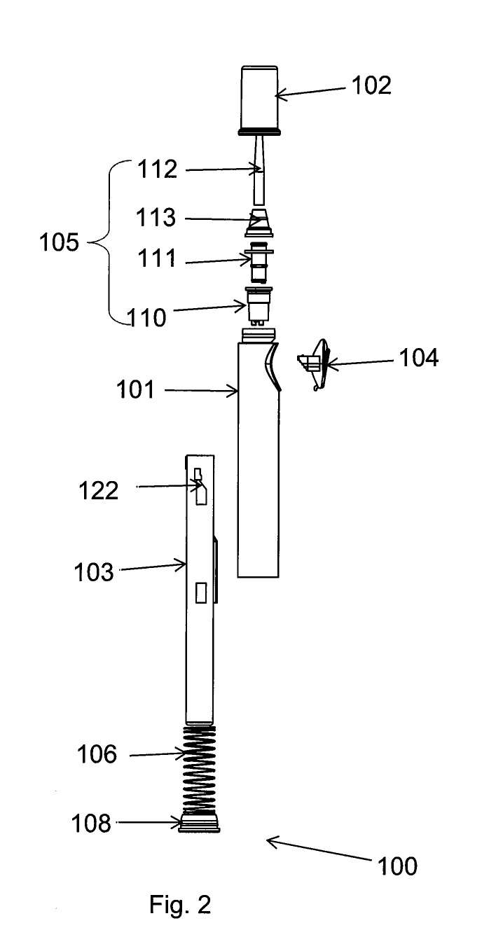

As represented by FIGS. 1 and 2, the dispensing device 100 comprises of an outer body 101 and a closure means 102 for the same. The outer body 101 is hollow and accommodates a reservoir 103, an actuating means 104 and a shearing assembly 105. The reservoir 103 contains the product. The reservoir 103 may further be made so as to form a replaceable cartridge and may be removably attached to the shearing assembly 105 so as to be used interchangeably by the user. The proximal end 106 of the reservoir 103 is arranged to be in fluid communication with the shearing assembly 105. The actuating means 104 is operatively connected to the reservoir 103. Further, the movement of the reservoir 103 with respect to the outer body 101 is biased by way of a biasing member 106 thereby allowing the reservoir 103 to be displaced in a translation motion when a force is applied on it. The biasing member 106 may be a coil spring which surrounds the reservoir 103 and its compression/retraction is controlled by providing projections 107 on the outer surface of the reservoir 103 and a plug 108 at its distal end 109 thereby giving it a directed path for compression/retraction. These projections 107 prevent the reservoir 103 from being accidentally pushed during storage and thereby ensuring that the device 100 is spill-proof. Also, the arrangement of the reservoir 103 with respect to the outer body 101 is such that the distal end 109 of the reservoir 103 is visible from the outer body 101 thereby showing the kind and color of the formulation stored in the reservoir 103.

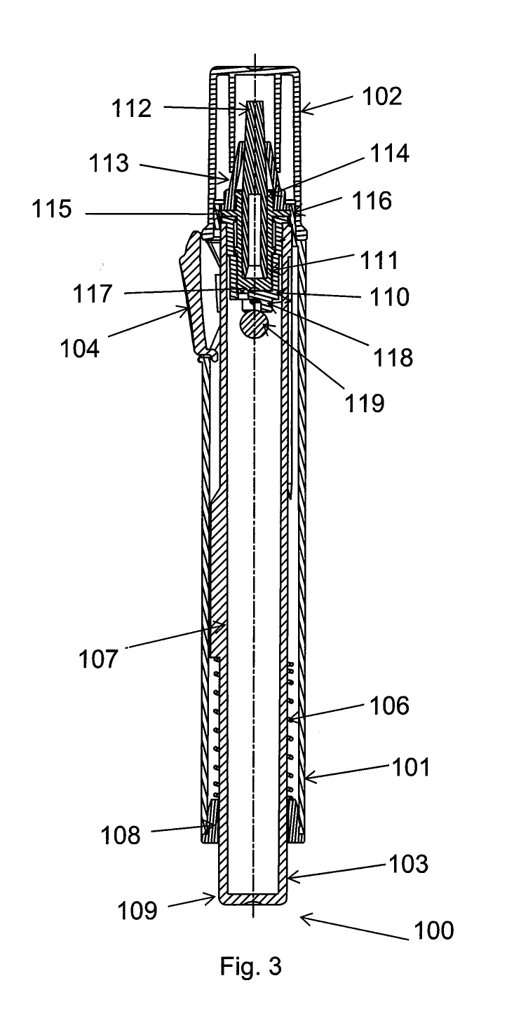

As depicted in FIG. 2, the shearing assembly 105 comprises a housing 110 that houses a shearing component 111 and an applicator element 112. The housing 110 of the shearing component 111 may further include a collar 113 wherein the collar 113 accommodates the applicator element 112 of the device 100 and also holds the shearing component 111. The collar 113 may optionally be so manufactured to be removably arranged in the housing 110 of the shearing assembly 105 in order to provide option of a plurality of applicator elements to be used interchangeably. The proximal end 114 of the shearing component 111 is fixedly connected to the outer body 101 with the help of corresponding projections 115 and grooves 116 on both the components. Also, there is provided a steel ball 119 that helps in mixing the components of the formulation before application. As shown in FIG. 3, the projections 115 on the shearing component 111 sit on corresponding grooves 116 in the proximal end of the outer body 101. Further, the shearing component 111 has a plurality of flow tracks in it and a solid region. The shearing component 111 has a projection 117 at its distal end arising from the solid region that fits onto the aperture of the housing 110 thereby providing sealing action for flow of product.

As depicted in FIGS. 2 and 3, the housing 110 of the shearing component 111 is connected with the reservoir 103. The housing 110 is arranged to be fitted at the neck of the reservoir 103. Further, the housing 110 of the shearing assembly 105 has a projection 118 at its distal end for stopping the steel ball 119 from clogging the aperture of the housing 110.

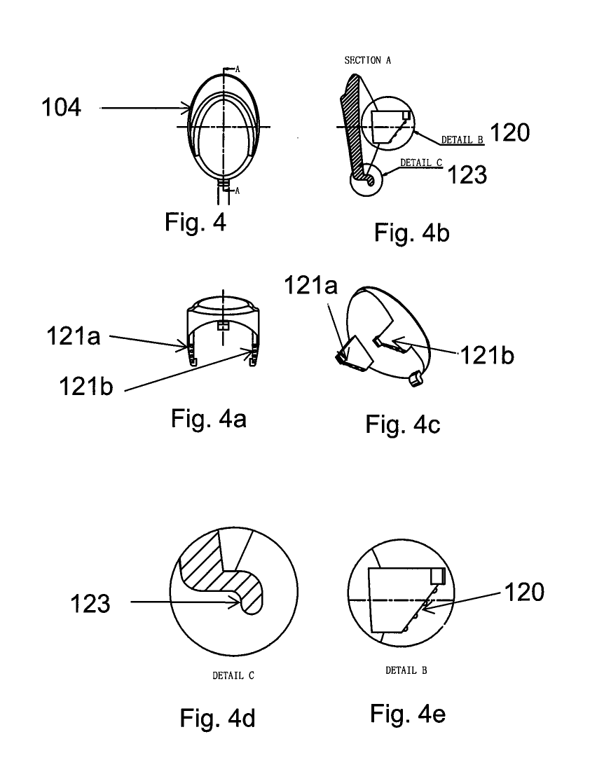

As shown in FIGS. 3 and 4, the actuating means 104 is so arranged that its actuation causes the reservoir 103 to displace axially and cause the flow of product to the applicator 112. The actuating means 104 may be any suitable means such as a slider, a push-button or a rotor. The actuating means 104 is connected to the reservoir 103 by way of a cam profile 120. As shown in FIGS. 4a and 4c, the actuating means 104 has two projections 121a and 121b on its sides which are connected to the reservoir 103. The projections 121a and 121b further have an inclined cam profile 120 as represented in FIGS. 4b and 4e. The cam profile 120 corresponds to a similar profile 122 on the reservoir 103. Further, as represented by FIGS. 4b, 4d, 5 and 6, the distal end of the actuating means has a projection 123 that fits onto a flange-like projection 124 in the outer body 101. When the actuating means 104 is actuated by the user, a force is applied on the reservoir 103 that causes it to be displaced axially which in turn takes the housing 110 of the shearing assembly 105 along with it. As the reservoir 103 rides on the inclined profile 120 of the actuating means 104, the housing 110 of the shearing assembly 105 is also displaced thereby opening the passage for the product to flow through the shearing component 111 onto the applicator 112. Further, the closure means 102 may be so arranged that the actuating means 104 is locked when the device 100 is not in use.

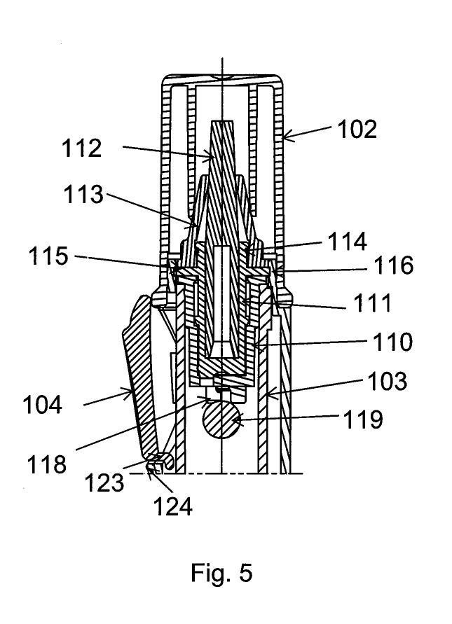

As represented by FIGS. 3 and 5, the device 100 is closed and not in use. When closed, the closure means 102 such as a cap sits on the proximal end of the outer body 101 such that the actuating means 104 is locked and its movement is blocked. Further, in closed position, the housing 110 and the shearing component 111 of the shearing assembly 105 are caused to be placed abutting each other and there is no flow of product taking place.

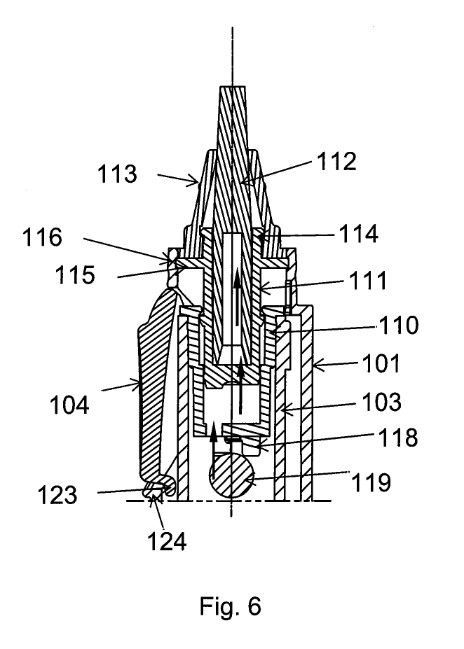

As shown in FIG. 6, the closure means 102 is removed from the device 100. In open position, when the actuating means 104 is actuated, the housing 110 and the shearing component 111 are placed apart as the reservoir 103 has displaced axially taking the housing 110 of the shearing assembly 105 along with it. Further, the aperture of the housing 110 of the shearing component 111 and therefore the flow tracks of the shearing component 111 are now open to allow the flow of fluid.

The materials for making various parts of the dispensing device 100 are selected as per the compatibility of the materials with the kind of formulation stored in the reservoir 103. The outer body 101 may be made of acrylonitrile butadiene styrene or any suitable polymeric material, while the closure means 102 may be made from polypropylene or any suitable polymeric material. The housing 110 of the shearing assembly 105 and the shearing component 111 may be made from any suitable material or a mixture of suitable polymeric materials, for example, the housing 110 may be made from polypropylene and the shearing component 111 may be made from hytrel or low density polyethylene or from a proportionate mixture of low density polyethylene and high density polyethylene. The actuating means 104 may be made from a suitable polymeric material such as acrylonitrile butadiene styrene or polypropylene. The reservoir 103 may be made of polyamide or a suitable polymeric material depending upon the product to be filled in the reservoir 103. The biasing member 106 is a resilient flexible member and could be a coil spring or such biasing element. The plug 108 for the biasing member 106 may be made from polypropylene or any suitable material.

The applicator 112 could be provided with different kinds of applicator elements which could be used interchangeably thereby providing a wide usage of the applicator. Further, the reservoir 103 may be made in the form of a replaceable cartridge which could be changed after each use or changed once the product is finished.

Although the above description and drawings show the device as being cylindrical, the shapes and profile cross section thereof are not limited to the same. The device of the present invention may be of any suitable shape such as square, rectangular, circular, polygonal.

The device 100 for consumer products of the present invention could also serve as a kit with varied options of products in the form of different cartridges in a single package wherein the cartridges may be replaced as per users requirement.

While the foregoing is directed to embodiments of the present invention, other and further embodiments of the invention may be devised without departing from the basic scope thereof, and the scope thereof is determined by the claims that follow.

What is claimed is:

1. A dispensing device for a consumer product comprising:
an outer body
wherein the outer body is hollow and accommodates a reservoir containing the product, an actuating means and a shearing assembly
wherein the reservoir is arranged to be in fluid communication with the shearing assembly and the actuating means is arranged to be operatively connected to the reservoir
wherein the outer body and the reservoir are arranged to be displaceable with respect to each other and wherein movement of the reservoir with respect to the outer body is biased by a biasing member; and
a closure means
wherein actuation of the actuating means causes the reservoir to be displaced axially by keeping the biasing member under an action of an applied force of the actuating means and thereby cause the product to be dispensed.

2. The dispensing device according to claim 1 wherein the shearing assembly comprises of a housing that houses a shearing component and an applicator element and wherein the housing has at least one aperture for fluid flow.

3. The dispensing device according to claim 2 wherein the shearing component is fixedly connected to the outer body and the housing of the shearing component is connected with the reservoir.

4. The dispensing device according to claim 3 wherein the shearing component has a plurality of flow tracks and a solid region wherein a projection arises from a distal end of said solid region.

5. The dispensing device according to claim 4 wherein the projection of the shearing component fits onto the at least one aperture of the housing thereby providing sealing action of flow of product.

6. The dispensing device according to claim 5 wherein an arrangement of the reservoir with respect to the outer body causes a distal end of the reservoir to be visible from the outer body.

7. The dispensing device according to claim 6 wherein the actuating means is a slider, a push-button, or a rotor.

8. The dispensing device according to claim 7 wherein upon actuation of the actuating means, a force by way of the biasing member is applied on a housing of the reservoir and the reservoir is displaced axially which in turn takes the housing of the shearing assembly alongwith it thereby opening a passage for the product to be dispensed through the shearing component onto the applicator element.

9. The dispensing device according to claim 8 wherein the actuating means is locked by the closure means when the device is not in use.

10. The dispensing device according to claim 9 wherein an exterior surface of the reservoir has indentations which prevent the product from being accidentally dispensed during storage.

11. The dispensing device according to claim 10 wherein in the device in closed position the closure means locks the actuating means and the housing and the shearing component of the shearing assembly are caused to be placed abutting each other and there is no flow of product taking place.

12. The dispensing device according to claim 11 wherein when the device is in an open position and when the actuating means is actuated, the housing and the shearing component are placed apart as the reservoir has displaced axially taking the housing of the shearing assembly alongwith it and opening the passage for flow of fluid.

13. The dispensing device for a consumer product according to claim 12 wherein the product comprises at least one of: a liquid cosmetic material, a cosmeceutical, a skin treatment product, and a hair treatment product.

14. The dispensing device according to claim 13 wherein the actuating means is connected to the reservoir by way of a cam profile.

15. The dispensing device according to claim 14 wherein the cam profile is an inclined cam profile and the cam profile corresponds to a similar profile on the reservoir.

16. The dispensing device according to claim 1 wherein materials for making various parts of the dispensing device are selected as per a compatibility of the materials with a kind of formulation stored in the reservoir.

17. The dispensing device according to claim 2 wherein a plurality of applicator elements are used interchangeably.

18. The dispensing device according to claim 1 wherein the reservoir is a replaceable cartridge.

19. A kit comprising the dispensing device according to claim 1 wherein the kit further comprises a plurality of cartridges and applicator elements.

20. A dispensing device for a consumer product comprising:
an outer body
wherein the outer body is hollow and accommodates a reservoir containing the product, an actuating means and a shearing assembly
wherein the shearing assembly comprises of a housing that houses a shearing component and an applicator element and wherein the housing has at least one aperture for fluid flow and wherein the shearing component has a plurality of flow tracks and a solid region wherein a projection arises from a distal end of said solid region and wherein the projection of the shearing component fits onto the at least one aperture of the housing thereby providing sealing action of flow of product
wherein the reservoir is arranged to be in fluid communication with the shearing assembly and the actuating means is arranged to be operatively connected to the reservoir
wherein the outer body and the reservoir are arranged to be displaceable with respect to each other and wherein a movement of the reservoir with respect to the outer body is biased by a biasing member
wherein the shearing component is fixedly connected to the outer body and the housing of the shearing component is connected with the reservoir
wherein an exterior surface of the reservoir has indentations that prevent the product from being accidentally dispensed during storage;
and
a closure means
wherein actuation of the actuating means causes the reservoir to be displaced axially by keeping the biasing member under an action of an applied force of the actuating means and thereby cause the product to be dispensed and wherein an arrangement of the reservoir with respect to the outer body causes the distal end of the reservoir to be visible from the outer body and wherein the actuating means is locked by the closure means when the device is not in use
wherein in the device in a closed position the closure means locks the actuating means and the housing and the shearing component of the shearing assembly are caused to be placed abutting each other and there is no flow of product taking place
wherein when the device is in an open position and when the actuating means is actuated, the housing and the shearing component are placed apart as the reservoir has displaced axially taking the housing of the shearing assembly alongwith it and opening a passage for flow of fluid
wherein the actuating means is connected to the reservoir by way of a cam profile wherein the cam profile is an inclined cam profile and the cam profile corresponds to a similar profile on the reservoir
wherein a plurality of applicator elements are used interchangeably and wherein the reservoir is a replaceable cartridge.
